(19) United States
(12) Patent Application Publication
(10) Pub. No.: US 2021/0269136 A1
(43) Pub. Date: Sep. 2, 2021

(54) MARINE OUTBOARD ENGINE TRANSPORTION APPARATUS INCLUDING A REMOVABLE DOLLY ASSEMBLY

(71) Applicant: RAIDER OUTBOARDS, INC., Titusville, FL (US)

(72) Inventor: Christopher Woodruff, Palmetto, FL (US)

(73) Assignee: RAIDER OUTBOARDS, INC., Titusville, FL (US)

(21) Appl. No.: 17/182,639

(22) Filed: Feb. 23, 2021

Related U.S. Application Data
(60) Provisional application No. 62/982,796, filed on Feb. 28, 2020.

(51) Int. Cl. B63H 20/36; B62B 3/00; B62B 3/04; B62B 3/02

(52) U.S. Cl. CPC B63H 20/36; B62B 3/002; B62B 2202/408; B62B 3/02; B62B 3/04

(57) ABSTRACT

Apparatus and methods for transporting a marine outboard engine include securing a marine outboard engine to an engine support cart having a pair of rear wheels and a pair of front wheels, wheeling the engine support cart into a cage assembly, and mounting a removable dolly assembly to the cage assembly. The dolly assembly includes a floor-engaging wheel. The marine outboard engine transportation apparatus with the marine outboard engine secured within is balanced on the pair of rear wheels and the floor-engaging wheel when the cage assembly is tilted backwards.

### CLAIM FOR PRIORITY

The present Application for Patent claims priority to U.S. Provisional Application No. 62/982,796 filed Feb. 28, 2020, assigned to the assignee hereof and hereby expressly incorporated by reference herein.

### TECHNICAL FIELD

The disclosed embodiments relate generally to apparatus for transporting a marine outboard engine.

### BACKGROUND

Marine outboard engines are heavy and cumbersome to transport. Manually transporting a marine outboard engine often entails mounting the outboard engine to a commonly used two-wheeled tilt cart. Transporting the outboard engine using a two-wheeled cart may require the individual to manually tilt back the cart on the rear wheels of the cart such that the entire weight of the outboard engine is resting on the rear wheels of the two-wheeled cart. Transporting an outboard engine in this manner presents an opportunity to damage the outboard engine and possible injury to the individual transporting the outboard engine.

### BRIEF DESCRIPTION OF THE DRAWINGS

The embodiments are described in detail in the following description with reference to the following figures. The figures illustrate examples of the embodiments.

FIG. 1 depicts an environmental view of a marine outboard engine transportation apparatus according to an example.

FIG. 2A depicts a side view of a marine engine support cart according to an example.

FIG. 2B depicts another view of the marine engine support cart according to an example.

FIG. 3 depicts a marine outboard engine mounted to the marine engine support cart according to an example.

FIG. 4 depicts a cage assembly according to an example.

FIG. 5 depicts an environmental view of an outboard marine engine transportation apparatus according to an example.

FIG. 6A depicts a removable dolly assembly according to an example.

FIG. 6B is an environmental view of the removable dolly assembly of FIG. 6A being mounted to a cage assembly according to an example.

FIG. 7 depicts an environmental view of a marine outboard engine transportation apparatus according to an example.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details.

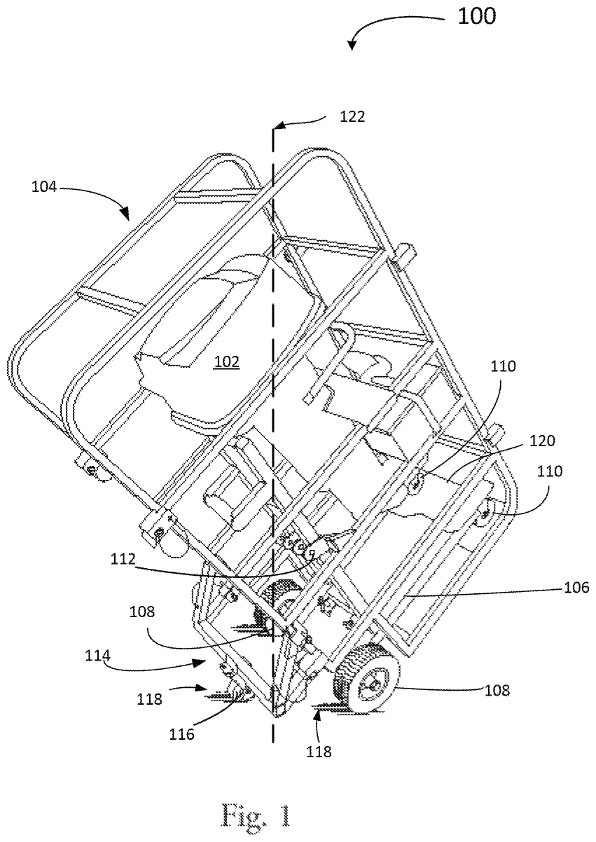

FIG. 1 generally depicts a marine outboard engine transportation apparatus 100 to move a marine outboard engine 102 safely, minimizing damage to the engine 102 and injury to an individual transporting the engine 102. Apparatus 100 includes an engine support cart 106 upon which a marine outboard engine 102 is securely mounted. A cage assembly 104 surrounds and protect the marine outboard engine 102 and engine support cart 106. A removable dolly assembly 114 having a ground-engaging wheel 116 is fixedly mounted to cage assembly 104.

Engine support cart 106 includes front wheels 110 and rear wheels 108, rear wheels 108 sized to have a diameter larger than front wheels 110. A marine outboard engine 102 mounted on engine support cart 106 is secured to cage assembly 104 using mounting brackets 112.

FIG. 1 depicts the transportation cage 104 tilted back and supported on rear wheels 108 and ground-engaging wheel assembly 116 of the removable dolly assembly 114. Front wheels 110 of engine support cart 106 are depicted as engaging skid 120 disposed in a lower front of cage assembly 104 and are raised off of the ground or other horizontal surface 118. A center of gravity 122 of cage assembly 104, engine support cart 106, and outboard engine 102 is depicted between ground-engaging wheel assembly 116 and rear wheels 108. In the operative state depicted in FIG. 1, the engine 102 may be transported with minimal risk of injury to the user, or damage to the engine 102.

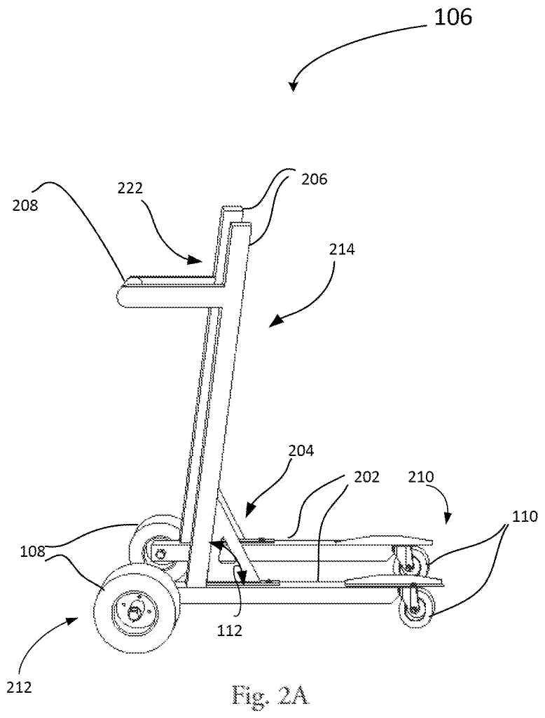

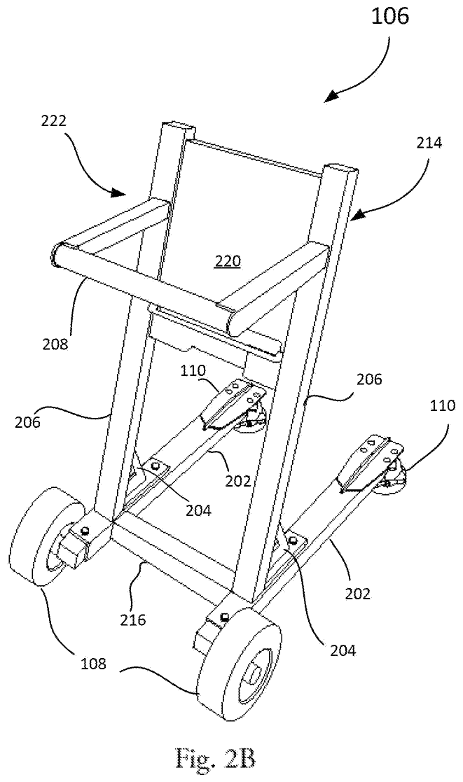

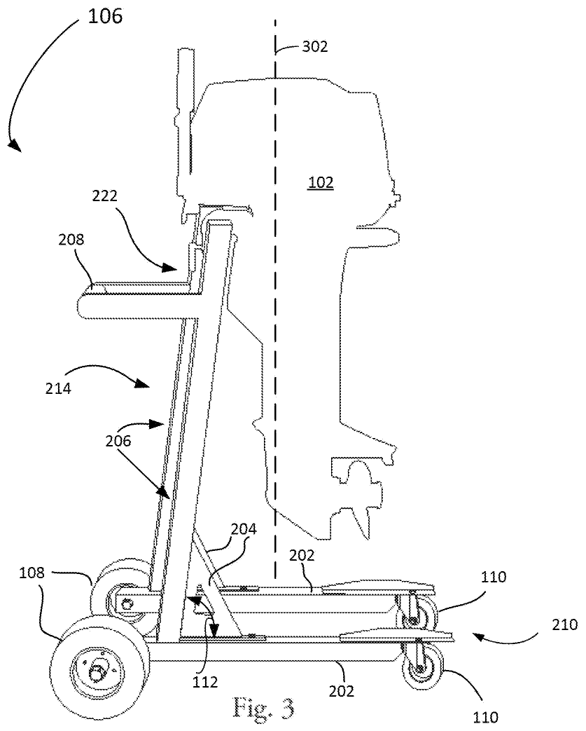

FIGS. 2A, 2B, and 3 depict an engine support cart 106 that includes an elongated engine support frame 214 of vertically angled support members 206 fixedly secured to a rear facing portion 212 of rail members 202. The elongated engine support frame 214 is secured in place by angled braces 204. An engine mounting bracket 220 is positioned in an upper portion 222 of the elongated support frame 214 forward of rear wheels 108. The engine mounting bracket 220 is fixedly attached to, and spaced between, vertically angled support members 206.

A rear facing handlebar 208 is disposed on the upper portion 222 of the elongated engine support frame 214 above rear wheels 108. A spacing between the vertically angled support members 204 is fixed by lower member 216, upper member 218, and handlebar 208 such that a width of engine support cart 106 is sized larger than a width of outboard engine 102. An angle 113, formed by the vertically angled support members 204 and the rail members 202, is such that a center of gravity 302 (FIG. 3) of outboard engine 102, is located at an approximate midpoint between front wheels 110 and rear wheels 108.

Front wheels 110 have a smaller diameter than rear wheels 108 and are swivel mounted to rail members 202. Rear wheels 108, rail members 202, and angled support members 204 are sized to support a weight of engine 102 when the engine support cart 106 is tiled back on rear wheels 108.

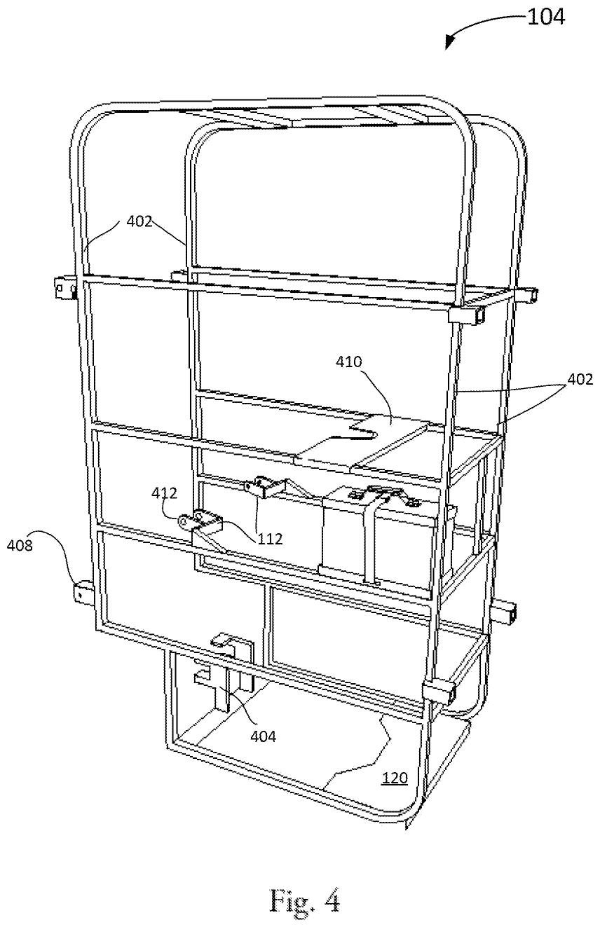

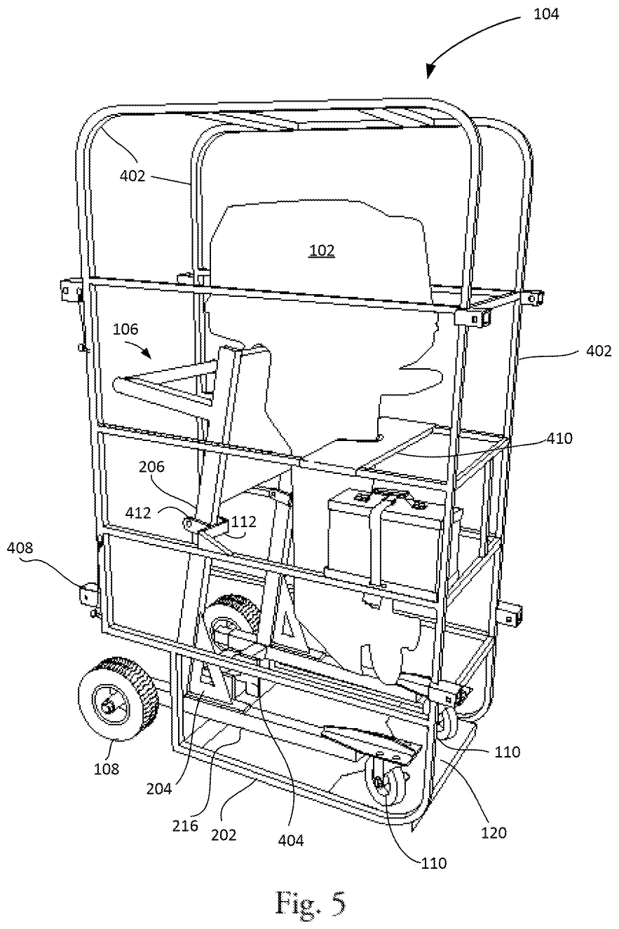

FIGS. 4 and 5 depict a cage assembly 104 sized to receive the engine support cart 106 and outboard engine 102. Cage assembly 104 includes frame members 402, engine support member 410, upper cart locking brackets 112, apertures or openings 412 disposed in upper cart locking brackets 112, lower cart locking bracket 404, skid plate 120, and dolly assembly receiving junctions 408.

FIG. 5 depicts engine support cart 106 with mounted outboard engine 102 wheeled into, and secured within, cage assembly 104. The front wheels 110 of engine support cart 102 roll onto skid plate 120. The vertically angled support members 206 of engine support cart 106 are received and secured in upper brackets 112 with pins, clips, or other fastening connectors inserted through axially aligned apertures 412. Horizontal member 216 of engine support cart 106 is received and secured to lower bracket 404 of cage assembly 106.

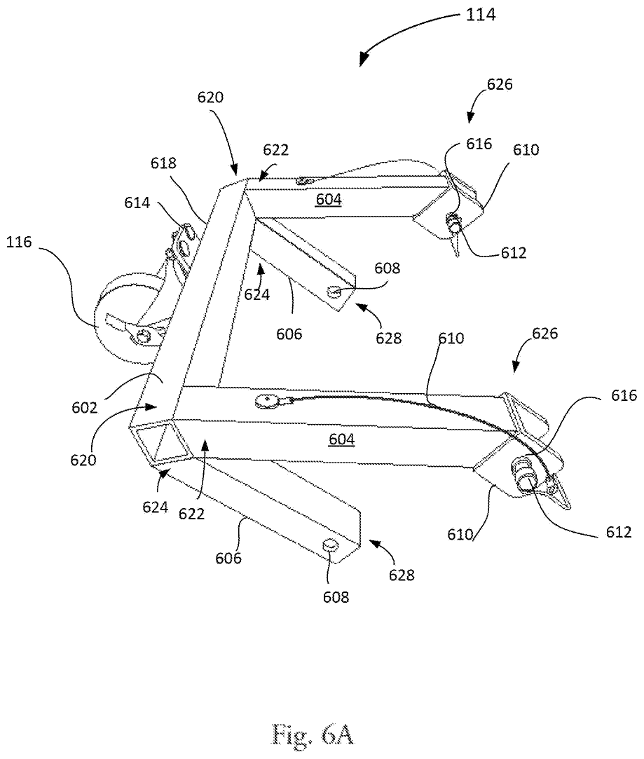

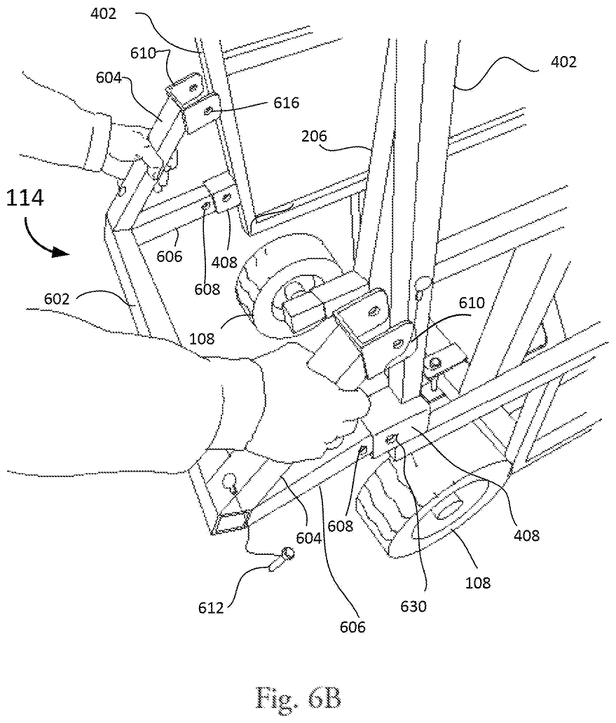

FIG. 6A depicts removable dolly assembly 114. FIG. 6B depicts removable dolly assembly 114 as it is attached to frame members 402 of cage 104. Removable dolly assembly 114 includes a wheel assembly 116 that in an embodiment is a swivel caster wheel that, as depicted in FIG. 1, is ground-engaging when the cage assembly 104 and engine support cart 106 is tilted back on rear wheels 108. In an embodiment, removable dolly assembly 114 is formed from rigid steel or aluminum extruded stock such as 6061 aluminum square tubing.

In an example, removable dolly assembly 114 includes a flange 614 fixedly attached by welding to a center portion of dolly frame member 602. Flange 614 is sized and positioned to extend beyond a rear facing side 618 of dolly frame member 602. In an embodiment, wheel assembly 116 is fixedly mounted to flange 114 by welds or bolts. In an example, flange 614 is sized and positioned to receive foot pressure when transportation cage 104 is tilted back to a position where wheel assembly 116 of dolly assembly 114 is ground-engaging.

Fixedly attached to each end 620 of frame member 602 are first ends 622 and 624 of mounting members 604 and 606, respectively. Ends 622 form an acute angle with ends 624. In an example, frame members 602, 604, and 606 are fixedly attached by welds.

Opposite ends 626, 628 of mounting members 604, 606, respectively, are formed and positioned as removable secured to frame member 402 of cage 104. In an example, U-shaped brackets 610 are fixedly attached by welding to mounting members 604. The U-shaped brackets 610 and ends 628 of mounting members 606 are removable secured to cage 106 by any suitable means such as pins and bolts.

FIG. 6A depicts apertures 616 formed in U-shaped brackets 610, and apertures 608 formed in ends 628 of mounting members 606. FIG. 6B depicts frame members 402 of cage assembly 104 received by U-shaped brackets 610 and are secured in place with pins 612. Dolly assembly receiving junctions 408 are disposed at a bottom of frame members 402 and receive the apertured ends 628 of dolly assembly 114. Apertures 630 disposed within dolly assembly receiving junctions 408 align with apertures 608 disposed in dolly assembly 114. In an example, removable dolly assembly is secured to cage assembly 106 with fastening connectors such as pins 612 or bolts.

FIG. 1 depicts cage assembly 106 tilted back such that wheel assembly 116 of removable dolly assembly 114 is ground-engaging with horizontal surface 118, and together with rear wheels 108 of engine support cart 106 support a weight of outboard engine 102 and engine support cart 104. Skid plate 120 is shown as raised above horizontal surface 118 when wheel assembly 116 is ground-engaged.

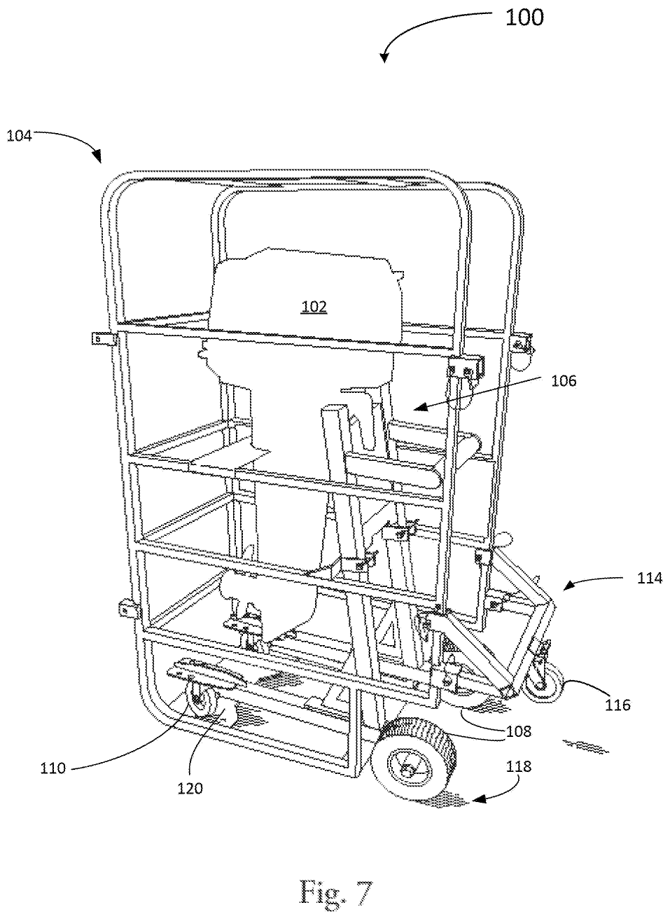

FIG. 7 depicts cage assembly 106 in an upright position resting on horizontal surface 118. Rear wheels 108 and skid plate 120 are ground-engaging, and wheel assembly 116 of dolly is raised above horizontal surface 118. In FIG. 7, the weight of transportation apparatus 100, including engine 102, is distributed on ground-engaging rear wheels 108 and skid pate 120.

Although elements of the described embodiments may be described or claimed in the singular, the plural is contemplated unless limitation to the singular is explicitly stated.

What is claimed is:

1. A marine outboard engine transportation apparatus comprising:
an engine support cart comprising:
a pair of spaced apart rail members having front ends and rear ends;
front wheels secured in a rotatable relationship to the front ends of the spaced apart rail members;
rear wheels secured in a rotatable relationship to the rear ends of the spaced apart rail members, the rear wheels having a diameter greater than the front wheels; and
an elongated engine support frame comprising:
spaced apart angled members, the angled members secured to, and extending in a fixed vertically angled relationship with, the rear ends of the spaced apart rail members;
a rearward facing handlebar fixedly attached to an upper portion of the elongated engine support frame; and
an engine mounting surface forward of the rear wheels and fixedly attached to the upper portion of, and between, the spaced apart angled members.
a cage assembly comprising:
a rectangular frame structure to receive the engine support structure, the rectangular frame structure comprising a front side, a rear side, a left side, and a right side;
locking brackets disposed on the rear side to receive and secure the engine support cart;
a ground-engaging skid plate disposed on a bottom front portion of the cage assembly, the skid plate to receive thereon the front wheels of the engine support cart; and
dolly assembly receiving junctions disposed on a bottom portion of the rear side of the rectangular frame structure; and
a dolly assembly removably attached to the rear side of the rectangular frame structure, the dolly assembly comprising:
a horizontal member having a first end and a second end, each of the first and second ends fixedly attached to a first end of an upper mounting member and a first end of a lower mounting member, each of the upper mounting members forming an acute angle with a corresponding lower mounting member at the first and second ends of the horizontal member;
upper and lower cage assembly mounting junctions disposed at second ends of the upper mounting members and the lower mounting members, wherein the lower cage assembly mounting junctions are sized to be received by the dolly assembly receiving junctions disposed on the bottom portion of the rear side of the rectangular frame structure; and
a wheel assembly mounted to a flange disposed on a center portion of the horizontal member, wherein the wheel assembly is ground-engaging when the cage assembly is tilted backwards on the rear wheels.

2. The marine outboard engine transportation apparatus according to claim 1, the dolly assembly further comprising a flange fixedly attached between the swivel wheel assembly and the horizontal member, the flange extending beyond a rear facing edge of the horizontal member.

3. The marine outboard engine transportation apparatus according to claim 1, wherein each of the upper cage assembly mounting junctions comprises a U-shaped bracket, an aperture disposed there through, and each of the lower cage assembly mounting junctions comprises an aperture disposed there through.

4. An attachable dolly assembly, the dolly assembly comprising:
a horizontal member having a first end and a second end, each of the first and second ends fixedly attached to a first end of an upper mounting member and a first end of a lower mounting member, each of the upper mounting members forming an acute angle with a corresponding lower mounting member at the first and second ends of the horizontal member;
upper and lower mounting junctions disposed at second ends of the upper mounting members and the lower mounting members; and
a swivel wheel assembly mounted to a flange fixedly attached to a center portion of the horizontal member.

5. A method of transporting a marine outboard engine, comprising:
securely mounting a marine outboard engine to an engine support cart, the engine support cart comprising:
a pair of spaced apart rail members having front and rear ends;
front wheels secured in a rotatable relationship with the front ends of the spaced apart rail members;
rear wheels secured in a rotatable relationship to the rear ends of the spaced apart rail members, the rear wheels having a diameter greater than a diameter of the front wheels; and
an elongated engine support frame comprising:
spaced apart angled members, the angled members secured to, and extending in a fixed vertically angled relationship with, the rear ends of the spaced apart rail members;
a rearward facing handlebar fixedly attached to an upper portion of the elongated engine support frame; and
an engine mounting surface forward of the rear wheels and fixedly attached to the upper portion of, and between, the spaced apart angled members;
securing the engine support structure to a cage assembly with fastening connectors, the cage assembly comprising:
a rectangular frame structure sized to receive the engine support structure and marine outboard engine, the rectangular frame structure comprising a front side, a rear side, a left side, and a right side;
locking brackets disposed on the rear side to receive and secure the engine support structure;
a ground-engaging skid plate disposed on a bottom front portion of the cage assembly, the skid plate to receive thereon the front wheels of the engine support structure; and
dolly assembly receiving junctions disposed on a bottom portion of the rear side of the rectangular the frame structure; and
removable attaching a dolly assembly to the rear side of the rectangular frame structure with fastening connectors, the dolly assembly comprising:
a horizontal member having a first end and a second end, each of the first and second ends fixedly attached to a first end of an upper mounting member and a first end of a lower mounting member, each of the upper mounting members forming an acute angle with a corresponding lower mounting member at the first and second ends of the horizontal member;
upper and lower cage assembly mounting junctions disposed at second ends of the upper mounting members and the lower mounting members, wherein the lower cage assembly mounting junctions are sized to be received by the dolly assembly receiving junctions; and
a dolly wheel assembly mounted to a flange disposed on a center portion of the horizontal member; and
tilting the cage backwards over the rear wheels of the engine support structure, whereby the wheel assembly is ground-engaging, and a weight of the marine outboard engine, the cage assembly, and the engine support structure is distributed over the rear wheels of the engine support structure and the dolly wheel assembly.
